(19) United States
(12) Patent Application Publication
(10) Pub. No.: US 2015/0046790 A1
(43) Pub. Date: Feb. 12, 2015

(54) OVERLAY OF PRIVATE DATA ON WEB PAGES

(71) Applicant: Avaya Inc., Basking Ridge, NJ (US)

(72) Inventors: Kundan Singh, San Francisco, CA (US); Venkatesh Krishnaswamy, Holmdel, NJ (US)

(73) Assignee: Avaya Inc., Basking Ridge, NJ (US)

(21) Appl. No.: 14/060,180

(22) Filed: Oct. 22, 2013

Related U.S. Application Data
(60) Provisional application No. 61/863,058, filed on Aug. 7, 2013.

(51) Int. Cl. G06F 17/24

(52) U.S. Cl. CPC G06F 17/24
USPC 715/234

(57) ABSTRACT

A connection is made to a first web page. Content of the first web page is displayed to the first user. Information about the first web page is received from the first user. A view of the first web page is modified and presented to the first user based on the information. The information is not sent to the web server associated with the first web page. Instead, the information is stored in a location that is associated with an organization that is associated with the first user. The organization is not associated with the web server. A connection is made to the first web page based on input from a second user. The second user is also associated with the organization. Based on the second user being associated with the organization, the stored information is retrieved and presented to the second user.

### RELATED U.S. PATENT APPLICATION DATA

This application claims the benefit under 35 U.S.C. §119(e) of U.S. Provisional Application No. 61/863,058 filed Feb. Aug. 7, 2013, entitled “OVERLAY PRIVATE INTERACTION AND DATA ON PUBLIC WEB PAGES,” which is incorporated herein by reference.

### TECHNICAL FIELD

The systems and methods disclosed herein relate to web services and in particular to controlling access to private data in web services.

### BACKGROUND

Often times, people interact and collaborate in the context of a web site. For example, a job posting page on Craigslist™ could provide the context for a job interview; likewise, a customer web site may provide the context for a sales team to discuss how to approach a customer. Existing collaboration systems have the ability to initiate and record interactions and share documents. However, existing collaboration systems do not tie the interactions to the web site that provided the context. Hence, when someone else views the web site he/she is unaware of the interactions that happened in regard to the web site. The crucial pieces of information from the previous discussion around the web site are either lost or not easily available because the information associated with the web site is found in different systems.

Another critical need is to keep this information private. With existing systems, control of private information is often difficult where a web site is external to an organization. In existing public web sites, the user typically does not control their private information. What is needed is a system that will work with any web site that ties private user information associated with a webpage or web site without exposing the private user information to sources outside an organization.

### SUMMARY

Systems and methods are provided to solve these and other problems and disadvantages of the prior art. A connection is made to a first web page based on input from a first user in a first browser. Content of the first web page is displayed to the first user. Information about the first web page is received from the first user. A view of the first web page is modified and presented to the first user based on the information. The information is not sent to the web server associated with the first web page. Instead, the information is sent and stored in a location that is associated with an organization that is associated with the first user. The organization is not associated with the web server.

A connection is made to the first web page based on input from a second user in a second browser. The second user is also associated with the organization. Based on the second user being associated with the organization, the stored information is retrieved. A view of the first web page is modified and presented to the second user based on the stored information.

### BRIEF DESCRIPTION OF THE DRAWINGS

FIG. 1 is a block diagram of a first illustrative system for controlling access to private information associated with a web page.

FIG. 2 is a diagram of a browser plug-in for controlling access to private information associated with a web page.

FIG. 3 is a diagram of providing private information to a second user based on an access rule.

FIG. 4 is a flow diagram of a process for controlling access to private information associated with a web page.

FIG. 5 is a flow diagram of a process for managing changed or invalid web pages.

FIG. 6 is a flow diagram of a process for providing private information to a second user based on an access rule.

### DETAILED DESCRIPTION

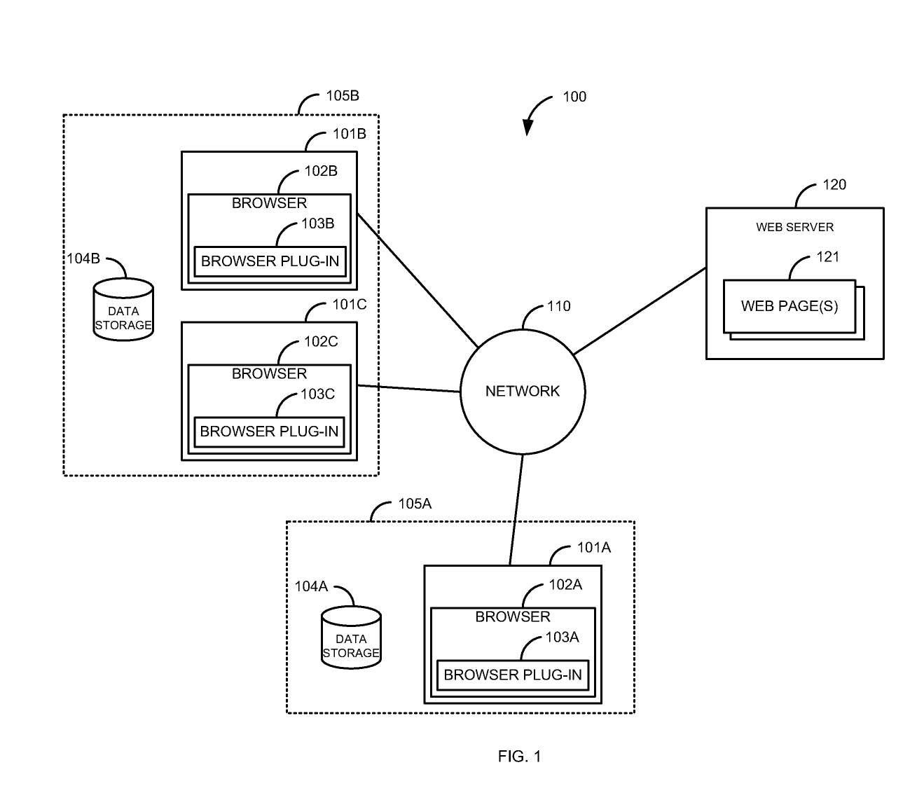

FIG. 1 is a block diagram of a first illustrative system 100 for controlling access to private information associated with a web page 121. The first illustrative system 100 comprises communication devices 101A-101C, data storage 104A-104B, organizations 105A-105B, a network 110, and a web server 120.

The communication device 101 can be or may include be any device that can communicate on the network 110, such as a Personal Computer (PC), a telephone, a video system, a cellular telephone, a Personal Digital Assistant (PDA), a tablet device, a notebook device, and/or the like. As shown in FIG. 1, there are three communication devices 101A-101C connected to the network 110. However, in other embodiments, any number of communication devices 101 may be connected to the network 110, including only a single communication device 101.

The communication device 101 further comprises a browser 102. The browser 102 can be or may include any type of browser, such as Firefox®, Internet Explorer®, Google Chrome™, Opera™, Safari™, and/or the like. The browser 102 further comprises a browser plug-in 103. The browser plug-in 103 can be or may include any software that can extend the functionality of the browser 102. The browser plug-in 103, in one embodiment, can be included as native functionality of the browser 102 (i.e., it is not a plug-in). The browser plug-in 103 can be a browser extension. The browser plug-in 103 can include a plurality of browser plug-ins 103 and/or extensions.

The data storage 104A-104B can be or may include any device or memory that can store electronic information, such as a Random Access Memory (RAM), a disk drive, a hard disk, a thumb drive, a disk array, a RAM disk, and/or the like. The data storage 104 may used to store information for an origination 105. For example, the data storage 104A can be used to store information related to the organization 105A. Likewise, the data storage 104B can be used to store information related to the organization 105B.

The organizations 105A-105B can be any type of organization, such as a group, a company, an enterprise, a partnership, and/or the like. Although FIG. 1 shows communication device 101A in organization 105A and communication devices 101B and 101C in organization 105B, the communication devices 101A-101C may be in multiple organizations 105. For example, communication device 101C may also be part of organization 105A.

The network 110 can be any collection of communication devices that can send and receive information, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of protocols, such as Ethernet, Hyper-text Transport Protocol (HTTP), Internet Protocol (IP), Session Initiation Protocol (SIP), Integrated Services Digital Network (ISDN), Web Real Time Communication (WebRTC), and the like.

The web server 120 can be or may include any hardware/software that can provide the web pages 121 to the communication devices 101A-101C. For example, the web server 120 may be an Apache web server running under the Linux® operating system that provides the web pages 121 to communication device 101A. The web server 120 may comprise a one or more web servers 120.

The web page 121 may be one or more web pages 121. The web page 121 is typically accessed using a Universal Resource Locator (URL)/Internet Protocol (IP) address. However, in other embodiments, other protocols may be used. The web page(s) 121 typically have a web domain and various web pages 121 associated with the web domain. For example, a web domain may be www.avaya.com. The domain www.avaya.com may include many other web pages 121, such as www.avaya.com/test. The web server 120 is typically a public web server 120, such as a web server on the Internet. However, in some embodiments, the web server 120 can be a web server that is private web server 120 that is shared between different organizations 105. More specifically, the web server 120 may be hosted within the domain of an organization 105 and web pages 121 may be shared with other organizations 105. Further still, the web server 120 may be locally hosted within a single organization 105 and certain sub-groups within that organization 105 (e.g., subsets of users, certain employees of the may only be allowed to access certain web pages 121 or certain aspects of certain web page 121.

A first user at the communication device 101B provides input to the browser 102B to connect to the web page 121 at web server 120. For example, the first user navigates to the web page 121 using the browser 102B. The web server 120 sends content of the web page 121 to the browser 102B. The browser 102B displays the content of the web page 121 to the first user in the browser 102B.

The browser plug-in 103B receives information about the web page 121 from the first user. The information about the web page 121 can be various kinds of information about or associated with the web page 121, such as a comment by the first user on the web page 121, a document, a link to a second web page 121, a video, an email, a text message, information associated with an Instant Messaging (IM) chat, an annotation, an interactive video session, an audio session, information from a white board, a shared notepad, a shared game, an email and/or the like. The browser plug-in 103B can receive information about the web page 121 from the first user in various ways. For example, the browser plug-in 103B may include an icon or similar selectable feature that appears on the browser 102B that the first user can click on or otherwise select. When the first user selects the icon in the browser 102B, the first user may be provided with a window to add a comment to the web page 121 as a non-limiting example. Alternatively, the first user may be provided with a window to attach a document, an email, a text message, a link to another web page 121, and/or the like to the web page 121.

Based on the received input, the browser plug-in 103B modifies a view of the web page 121 presented to the first user based in the received information. The browser plug-in 103B can modify the view of the web page 121 by overlaying the information over the web page 121. Alternatively, the browser plug-in 103B may modify the view of the web page 121 by bring up a new window or tab in the browser 102B.

In one embodiment, the browser plug-in 103B can modify the view by actually modifying the content of the web page 121 that is sent by the web server 120. For example, the browser plug-in 103B can modify the HTML or JavaScript code sent by the web server 120. In this embodiment, the content of the web page 121 and the information is presented to the first user at the same time. In another embodiment, an overlay with the information is presented before the content of the web page 121 is displayed to the first user.

The information is not sent to the web server 120 associated with the web page 121. Instead, the browser plug-in 103B sends and stores the information in a location (data storage 104B) that is associated with the organization 105B. In this example, the organization 105B is not associated with the web server 120.

A second user at the communication device 101C provides input to the browser 102C to connect to the web page 121 at the web server 120. The web server 120 sends content of the web page 121 to the browser 102C. The browser 102C displays the content of the web page 121 to the second user. The browser plug-in 103C determines that the second user at the communication device 101C is in the same organization 105B as the first user. In response to determining that the second user is in the same organization 105B, the browser plug-in 103C retrieves the information stored in the data storage 104B. The browser plug-in 103C modifies the view of the web page 121 presented to the second user based on the stored information (the information provided by the first user at communication device 101B).

At this point, the second user at the communication device 101C can also add information associated with the web page 121. Using the same process described above, the browser plug-in 103C receives additional information about the web page 121 from the second user. The browser plug-in 103C modifies the view of the web page 121 based the information provided by the first user and the additional information provided by the second user. The browser plug-in 103C does not send the additional information to the web server 120. The browser plug-in 103C sends and stores the additional information in the location that is associated with the organization 105A (data storage 104A).

The advantage of the above system is that the user data is stored and controlled by the respective organization 105 in their respective data storage 104. If a user from the organization 105A accesses the same web page 121 as the first and second users in the organization 105B, the user in the second organization 105A will not see the information posted by the first and second users. Likewise, if the user at communication device 101A posts a comment, the first and second users in organization 105B will not see the comment posted by the user from the organization 105A.

In the above examples, the data storage 104 is tracked based on an individual web page 121. For example, if the first user posted a comment on the web page 121 www.avaya.com, the posted comment would be associated with the web page 121 www.avaya.com. When the first user and the second user view the web page 121 www.avaya.com, the comment posted by the first user in regard to the web page 121 www.avaya.com would be displayed. Likewise, if the first user posted a different comment while viewing the web 121 www.avaya.com/test, the different comment would be associated and displayed when the first or second users navigated to the web page 121 www.avaya.com/test.

However, in an alternative embodiment, the information that is stored is associated with a domain or a group of web pages 121. If the information is based on a domain, the information is associated with all the web pages 121 of the domain. For example, if the first user posted a first comment while viewing www.avaya.com and a second comment while viewing www.avaya.com/test, both comments would be displayed while the first or second users viewed either of the two web pages 121 www.avaya.com or www.avaya.com/test (or any other web pages under the domain www.avaya.com).

In another embodiment, the information may be associated with a group of web pages 121. For example, for the information may be associated with all the web pages 121 under the URL www.avaya.com/test (e.g., www.avaya.com/test/test1 and www.avaya.com/test2). In the above examples, weather the information is associated with a domain or group of web pages 121, the control of how the information is associated with the web page may be defined in a user or administrative profile (or with an administrative utility).

In another embodiment, the user can subscribe to receive notifications when the stored information is changed by another user. For example, the first user will be notified when a second user adds a note to the web page.

In another embodiment, the information about the web page 121 may be received from an automated source instead of from the user. The automated source can send the information about the web page 121 based on content that is related to the web page 121. For example, if the first user and a second user exchange one or more emails in regard to the web page; the automated source can send the one or more emails to be received by the data storage 104. In this example, the information can be various types of information, such as a recorded video communication, a recorded voice communication or voice message, a recorded Instant Message, a stored document (that discusses the web site), a stored video with information related to the web site), and/or the like.

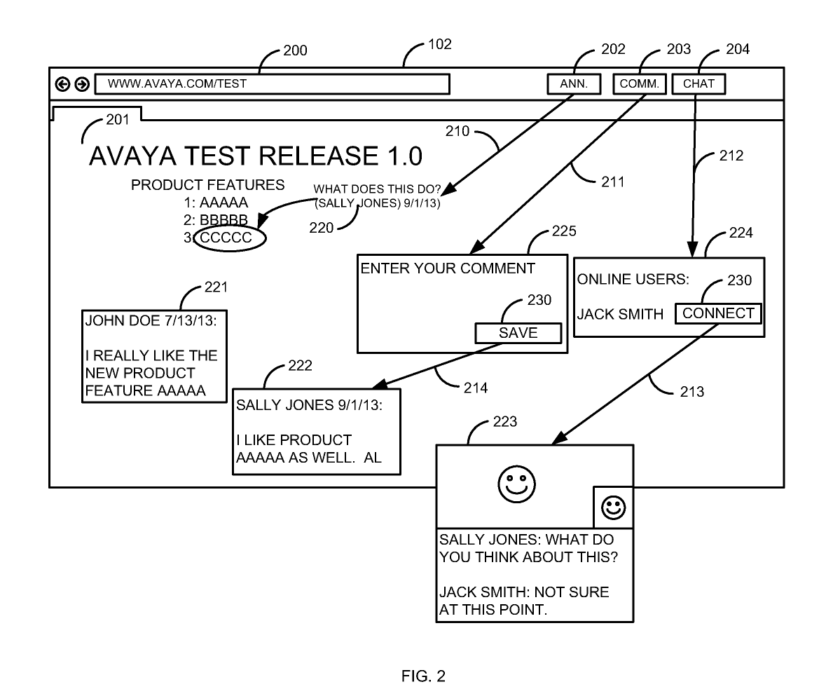

FIG. 2 is a diagram of a browser plug-in 103 for controlling access to private information associated with a web page 121. FIG. 2 is an illustrative example of a browser 102. In this example, the browser 102 comprises a URL link to a web page 200, a web page viewing area 201, an annotation icon 202, a comment icon 203, and a chat icon 204.

The URL link to a web page 200 is where the user provided input on which web page 121 the user wants to connect to. The web page viewing area 201 is used to display the content of the web page 121 along with the information received from the user. In this example, the user has navigated to the web page 121 www.avaya.com/test and the content of the web page 121 www.avaya.com/test is displayed in the web page viewing area 201.

In this example, the browser plug-in 103 is implemented as a series of icons 202-204 that provide different features of the browser plug-in 103. The browser plug-in 103 may be downloaded and installed into the browser 102 or can be part of the browser 102. This exemplary implementation of the browser plug-in 103 uses icons. However, one of ordinary skill in the art would recognize that other options may be used in place of icons, such using menus, buttons, tabs, and/or the like.

The annotation icon 202 is used by the user to make annotations to the web page content. The comment icon 203 allows the user to make comments on the web page 121. The chat icon 204 allows the user to communicate with other users viewing the web page 121 at the same time. Although not shown, other icons may be displayed. For example, an icon for attaching documents, web links, video files, and/or the like may also be part of the browser plug-in 103.

A user (Sally Jones) clicks on the annotation icon 202 in step 210. Upon clicking on the annotation icon 202 in step 210, Sally Jones can make annotations 220 to the existing web content (i.e., using a mouse or touch screen and keyboard). In this example, Sally Jones has circled the product feature CCCCC and has added a note with an arrow pointing to the product feature CCCCC. The comment indicates that Sally Jones wants to know what this feature does. Another user could make additional annotations from a second browser 102.

In this example, a previous user (John Doe) who viewed the web site www.avaya.com/test has left a comment 221. John Doe's comment indicates that he really likes the new product feature AAAAA. In this example, John Doe's comment is overlaid on top of the content of the web page 121 that is displayed in the web page viewing area 201.

Sally Jones clicked on the comment icon 203 in step 211 to post a comment. Sally Jones is provided with a text box 225 to enter a comment. Sally Jones enters the comments and saves the comment by clicking on save button 230 to save the comment. The comment 222 is posted on the web page 121 in the web page viewing area 201 in step 214. In one embodiment, Sally Jones can move the comment and post it where she wants.

Sally Jones can provide input to the browser plug-in 103 by clicking on the chat icon 204 to bring up a window 224 that shows which users in the organization are viewing the web page 121 at the same time in step 212. The browser plug-in 103 associates a communication identifier with the web page 121 when a user views (navigates to) the web page 121. As additional users view the web page 121, the browser plug-in 103 associates each of the viewing users with the communication identifier. In this example, Jack Smith is viewing the web page 121 at the same time as Sally Jones (as illustrated in window 224). Sally Jones can click on the connect button 230 next to Jack Smith's name to establish a communication session with Jack Smith in step 213. In this example, a video chat session is shown in window 223 (likewise, Jack Smith will also see the video chat session in his browser). However, in other embodiments, other types of communication sessions can be established, such as a voice chat, a text chat, an email exchange, an Instant Message (IM) chat, and/or the like.

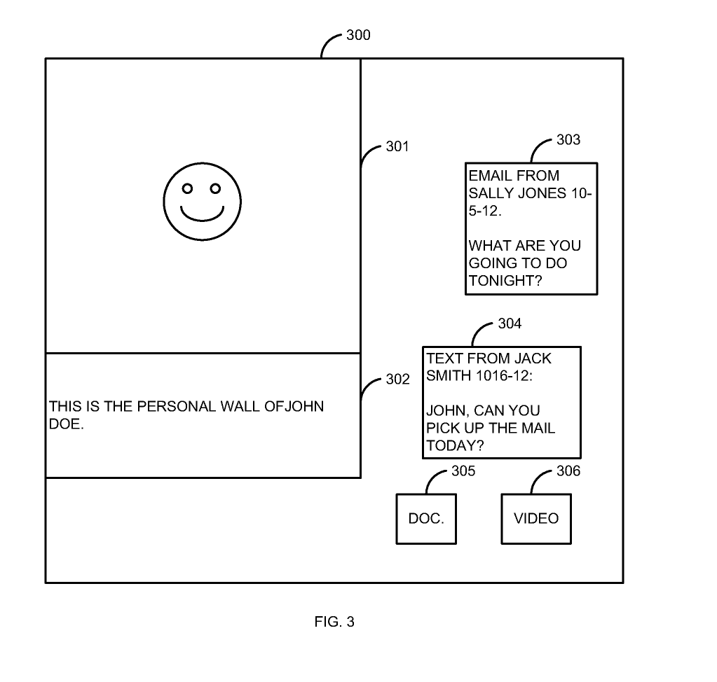

FIG. 3 is a diagram of providing private information to a second user based on an access rule. FIG. 3 comprises a representation of information associated with a first user. FIG. 300 comprises the first user's personal wall 300, a picture of the first user 301, a personal information text 302 of the first user. An email of the first user 303, a text message of the first user 304, a document 305, and a video 306.

In this example, FIG. 3 is an illustration of a personal wall of John Doe. The first user defines information associated with the first user. In this example, the user has defined his picture 301 and the personal information text 302 that will be displayed every time the user's wall 300 is displayed. The email 303, the text 304, the document 305, and the video 306 may be defined has having a context with another user. For example, the email 303 has a context with Sally Jones. The text 304 has a context with Jack Smith. Likewise, the doc 305 and the video 306 may also have a context with another user.

The defined information is stored in a memory (e.g., data storage 104) that is separate from the web page 121. The first user defines access rules that allow access to another user. For example, the first user may define an access rule that allows all messages associated with Jack Smith (e.g., text 304) to be displayed when the wall 300 is displayed to Jack Smith. The process is not limited to messages, but can be any kind of interaction, such as a text, an email, voice mail, a video, a document received from a user, a video of a user, and/or the like. Likewise, the first user may define an access rule that allows all the messages associated with Sally Jones (e.g., email 303) to be displayed when the wall 300 is displayed to Sally Jones. This way, elements 303-306 may be selectively displayed to other users based on what user is viewing the wall 300.

The first user and a second user can have an account on a social networking site, such as Facebook®, Linkedin®, and/or the like. When the second user (e.g., Jack Smith) logs into the social networking site and connects to the web page 121 of the first user, the browser plug-in 103 modifies the view of the web page 121 of the first user that is presented to Jack Smith. In this example, based on the access rule that only allows messages associated with Jack Smith to be displayed, Jack Smith sees the wall of John Doe that includes elements 301, 302, and 304. Elements 303, 305, and 306 are not displayed to Jack Smith because they are messages that are not associated with Jack Smith.

In the above, process the access rule filters the information differently based the second user accessing a second media social network. In this example, the elements 303, 305, and 306 are not shown to Jack Smith. If another user (e.g., Sally Jones) was to view John Doe's web page 121 on the same social networking site, Sally Jones would see elements 301, 302, 303, and 306 (assuming video 306 was a video of Sally Jones).

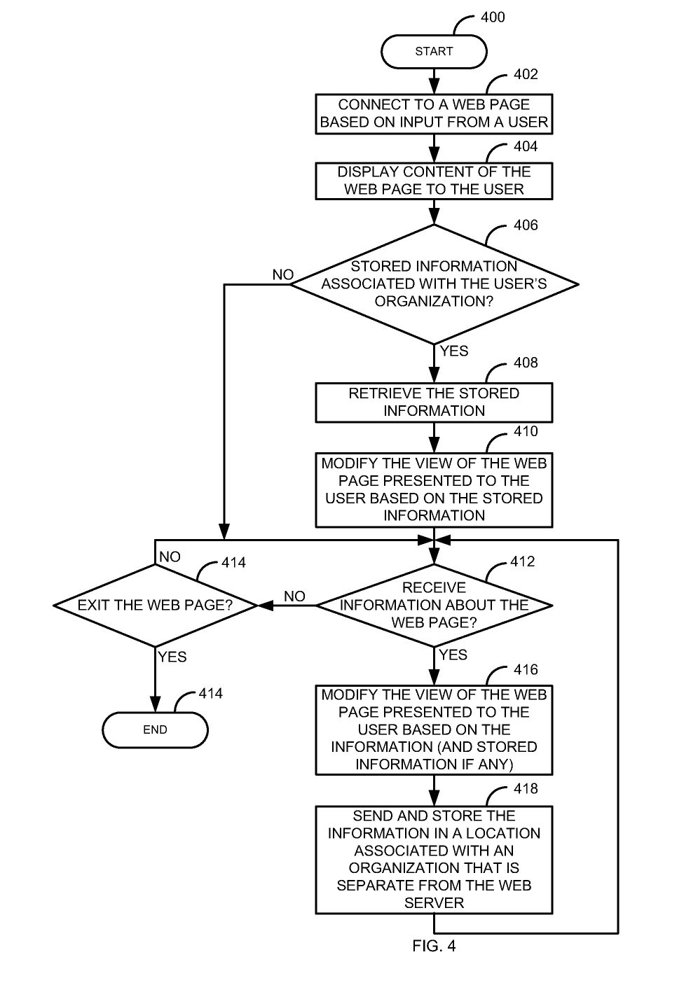

FIG. 4 is a flow diagram of a process for controlling access to private information associated with a web page. Illustratively, the communication device 101, the browser 102, the browser plug-in 103, the data storage 104, the network 110, the web server 120, and the web pages 121 are stored-program-controlled entities, such as a computer or processor, which performs the method of FIGS. 4-6 and the processes described herein by executing program instructions stored in a tangible computer readable storage medium, such as a memory or disk. Although the methods described in FIGS. 4-6 are shown in a specific order, one of skill in the art would recognize that the steps in FIGS. 3-5 may be implemented in different orders and/or be implemented in a multi-threaded environment. Moreover, various steps may be omitted or added based on implementation.

The process starts in step 400. The process connects to a web page based on input from a user in step 402. After getting the content, the process displays the content of the web page to the user in step 404. The process determines in step 406 if there is stored information for the web page associated with the user's organization (e.g., if another user in the organization has previously added information associated with the web page). If there is not stored information for the web page that is associated with the user's organization in step 406, the process goes to step 412.

Otherwise, if there is stored information associated with the user's organization in step 406, the process retrieves the stored information in step 408. The process modifies the view of the web page presented to the user based on the stored information in step 410.

The process determines in step 412 if information about the web page has been received from the user. If the information has not been received from the user in step 412, the process determines in step 414 if the user has exited the web page. For example, the user can exit the web page by closing the browser or navigating to a new web page. If the user has exited the web page in step 414, the process ends in step 414. Otherwise, if the user has not exited the web page in step 414, the process goes to step 412 to determine if information about the web page has been received from the user.

If the process receives information about the web page from the user in step 412, the process modifies a view of the web page presented to the user based on the information in step 416. Modifying the view of the web page does not send the information associated with the web page to the web server. Instead, the process sends and stored the information in a location associated with the organization in step 418. The location is separate the web server in step 418. The process goes back to step 412.

To further illustrate, consider the following example. A first user in a first organization wants to conduct an interview of a person who has posted a resume on a social networking site. At the start of the interview, the first user goes to a web page of the web site and brings up the person's resume. During the interview, the user posts several comments in regard to the person. The first user then exits the web page. A second user from the organization connects to the same web page where the person's resume is stored. The second user sees the comments made by the first user in regard to the person's resume. The second user also interviews the person and also makes comments. The comments made by the first and second user will only be shown to members of the same organization.

In another embodiment, the person being interviewed can also make comments that are stored in the data storage. The person being interviewed can add a comment that he could view later. The comment can also be viewed by the first and second users. However, the comments made by the first and second users are not visible to the person being interviewed. In another embodiment, the first or second person can make individual comments viewable by the person being interviewed.

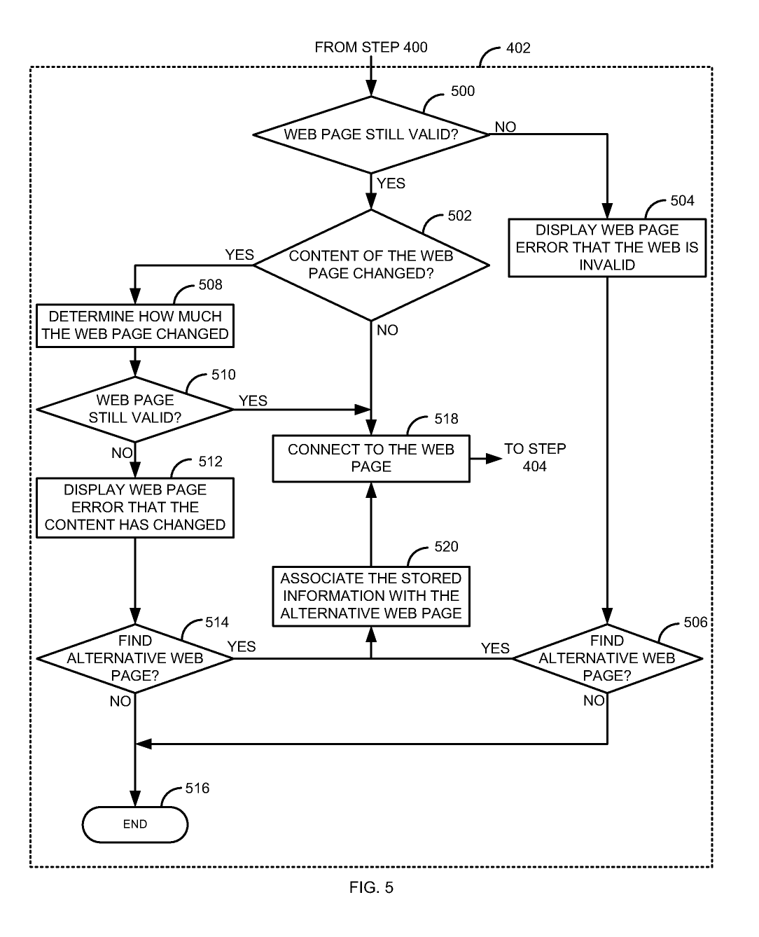

FIG. 5 is a flow diagram of a process for managing changed or invalid web pages. The process in FIG. 5 is an exemplary embodiment of step 402 in FIG. 4. After starting in step 400, the process determines in step 500 if the web page is still valid. A web page may be no longer valid because the URL is no longer valid, the IP address is no longer valid, and/or the like. If the web page is no longer valid in step 500, the process displays a web page error that the web page is no longer valid in step 504.

The process determines in step 506 if an alternative web page was found. For example, the process could search the domain of the web server for a web page that is similar or identical to the web page (that now has a different URL). The web page could be determined to be similar in various ways, such as based on comparing stored content of the web page to content of other web pages in the same domain.

If an alternative web page was found in step 506, the process associates the stored information with the alternative web page in step 520. The user is connected to the alternative web page by redirecting the user to the alternative web page in step 518. In one embodiment, the user may be notified that the user has been redirected to the alternative web page. Alternatively, the user may not be notified. The information is then displayed to the user while viewing the alternative web page. If an alternate web page was not found in step 506, the process goes to step 516 and ends. In this example, when the process goes to step 516, the information is not displayed to the user. In one embodiment, the process may delete the information associated with a web page that is no longer valid before going to step 516.

If the process determines that the web page is still valid in step 500, the process determines if the content of the web page has changed in step 502. If the content of the web page has not changed (or has only changed in an insignificant way) in step 502 the process goes to step 518 and connects to the web page.

Otherwise, if the content of the web page has changed in step 502, the process determines how much the content of the web page has changed in step 508. The process can determine in step 508 how much the content of the web page has changed based on various factors, such as based on a percentage of change of the total content, based on keyword searches, by displaying a comparison to the user and receiving an indication that the user believes that the content has changed or not, and/or the like. Based on this information, the process determines in step 510 if the web page is still valid. If the web page is still valid in step 510, the process connects to the web page in step 518.

Otherwise, if the process determines in step 510 that the web page is no longer valid, the process displays a web page error message to the user that the content of the web page has changed since the last information was received from the user (or another user) in step 512. The process determines in step 514 if an alternative web page can be found (similar to step 506). If an alternate web page was found in step 514, the process goes to step 520 and associates the stored information with the alternative web page. The process connects to the alternate web page (and later displays the information associated with previous web page when the alternate web page is viewed by the user) by redirecting the user to the alternate web page in step 518. The user may or may not be notified that the user has been redirected to the alternative web page. If the process cannot find an alternative web page in step 514, the process ends in step 516. In this example, the information is not displayed to the user. The information may be deleted if an alternative web page cannot be found in step 514.

In an alternative embodiment, if the process cannot find an alternative web page, the process can associate the information with the domain URL of the web page. At a later point in time, the user may be able to re-associate the information to another web page.

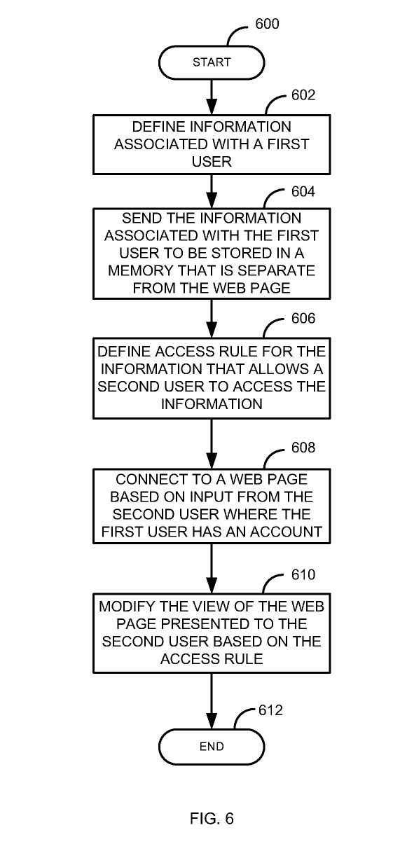

FIG. 6 is a flow diagram of a process for providing private information to a second user based on an access rule. The process starts in step 600. The process defines information associated with a first user (i.e., information as shown in FIG. 3). For example, the first user can define information such as personal information, emails, text messages, documents, voice messages, video messages, video files, and/or the like to be associated with the first user. The information associated with the first user is sent and stored in step 604 in a memory that is separate from the web page.

The first user defines one or more access rules for the information to allow a second user to access the stored information in step 606. The second user connects to a web page based on input from the second user via a web browser in step 608. The web page can be a web page of a social network where the first user and the second user have an account. A browser plug-in of the web browser modifies a view of the web page presented to the second user based on the access rule defined by the first user in step 610. The process ends in step 612.

The information of the first user can comprise interactions between the first and second user outside the social media network. For example, the information can contain emails, texts, videos, documents, voice messages, and/or the like. The access rules can filter the information differently based the second or a third user accessing a second media social network. For example, the access rule can specify that documents associated with Sally Jones will only be shown to Sally Jones, while documents associated with Jack Smith will only be shown to Jack Smith.

Of course, various changes and modifications to the illustrative embodiment described above will be apparent to those skilled in the art. These changes and modifications can be made without departing from the spirit and the scope of the system and method and without diminishing its attendant advantages. The following claims specify the scope of the invention. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
connecting to a first web page based on input from a first user in a first browser;
displaying content of the first web page to the first user;
receiving first information about the first web page from the first user;
modifying a view of the first web page presented to the first user based on the first information, wherein modifying the view of the first web page presented to the first user does not send the first information to a web server associated with the first web page; and
sending the first information to be stored in a location that is associated with an organization associated with the first user, wherein the organization is not associated with the web server.

2. The method of claim 1, further comprising:
connecting to the first web page based on input from a second user in a second browser, wherein the second user is also associated with the organization;
determining that there is stored first information for the web page associated with the organization;
in response to determining that there is stored first information for the web page associated with the organization, retrieving the stored first information; and
modifying the view of the first web page presented to the second user based on the stored first information.

3. The method of claim 2, further comprising:
receiving second information about the first web page from the second user;
modifying a view of the first web page presented to the second user based on the stored first information and the second information, wherein modifying the view of the first web page presented to the second user does not send the second information to the web server associated with the first web page; and
storing the second information in the location that is associated with the organization associated with the first user.

4. The method of claim 2, wherein the first and second users are connected the first web page at the same time and further comprising:
in response to connecting to the first web page by the first user and the second users, associating a communication identifier with the first web page;
receiving input from the first user via the first browser to establish a communication session with the second user; and
establishing the communication session between the first and second users.

5. The method of claim 4, wherein the communication session a chat session that is displayed in the first and second browsers to the first and second users, respectively.

6. The method of claim 1, further comprising:
connecting to the first web page based on input from a second user in a second browser, wherein the second user is also associated with the organization;
determining if at least one of:
a portion of the content of the first web page has changed; and
the first web page is no longer valid; and
in response to determining that the portion of the content of the first web page has changed or the first web page is no longer valid, not displaying the stored first information to the second user.

7. The method of claim 1, further comprising:
connecting to the first web page based on input from a second user in a second browser, wherein the second user is also associated with the organization;
determining at least one of:
a portion of the content of the first web page has changed; and
the first web page is no longer valid;
in response to determining that the portion of the content of the first web page has changed or the first web page is no longer valid, searching the web server for a second web page that is similar or the same as to the first web page;
redirecting the first user to the second web page;
associating the first information with the second web page; and
displaying the stored first information to the second user.

8. The method of claim 1, wherein the first web page comprises a plurality of first web pages in a domain and further comprising:
connecting to different ones of the plurality of first web pages based on input from the first user in the first browser;
receiving second information about the different ones of the plurality of first web pages from the first user; and
wherein the modifying a view of any one of the different ones of the plurality of first web pages comprises displaying the stored first information and the second information.

9. The method of claim 1, wherein the first information about the first web page comprises at least one of: a comment by the first user on the first web page, a document, a link to a second web page, a video, a document, a text message, an annotation, an interactive video session, an audio session, a white board message, a shared notepad, a shared game, and an email.

10. The method of claim 1, further comprising:
receiving second information about the web page from an automated source, wherein the automated source automatically sends the second information about the web page based on content of a communication between the first user and a second user, wherein the content is related to the web page; and
sending the second information to be stored in the location associated with the organization associated with the first user.

11. A system comprising:
a first browser configured to connect to a first web page based on input from a first user and display content of the first web page to the first user;
a first browser plug-in configured to receive first information about the first web page from the first user, modify a view of the first web page presented to the first user based on the first information, wherein modifying the view of the first web page presented to the first user does not send the first information to a web server associated with the first web page, and send the first information to be stored in a location that is associated with an organization associated with the first user, wherein the organization is not associated with the web server.

12. The system of claim 11, further comprising:
a second browser configured to connect to the first web page based on input from a second user, wherein the second user is also associated with the organization;
a second browser plug-in configured to determine if there is stored first information for the web page associated with the organization, retrieve the stored first information in response to determining there is stored first information for the web page associated with the organization, and modify the view of the first web page presented to the second user based on the stored first information.

13. The system of claim 12, wherein the second browser plug-in is further configured to receive second information about the first web page from the second user, modify a view of the first web page presented to the second user based on the stored first information and the second information, wherein modifying the view of the first web page presented to the second user does not send the second information to the web server associated with the first web page, and send the second information to be stored in the location that is associated with the organization associated with the first user.

14. The system of claim 12, wherein the first and second users are connected the first web page at the same time and wherein the first browser plug-in is further configured to associate a communication identifier with the first web page in response to connecting to the first web page by the first user and the second users, receive input from the first user via the first browser to establish a communication session with the second user, and establish the communication session between the first and second users.

15. The system of claim 14, wherein the communication session a chat session that is displayed in the first and second browsers to the first and second users respectively.

16. The system of claim 11, further comprising:
a second browser configured to connect to the first web page based on input from a second user, wherein the second user is also associated with the organization;
a second browser plug-in configured to determine if at least one of: a portion of the content of the first web page has changed and the first web page is no longer valid, and not display the stored first information to the second user in response to determining that the portion of the content of the first web page has changed or the first web page is no longer valid.

17. The system of claim 11, further comprising:
a second browser configured to connect to the first web page based on input from a second user, wherein the second user is also associated with the organization;
a second browser plug-in configured to determining if at least one of: a portion of the content of the first web page has changed and the first web page is no longer valid, search the web server for second web page that is similar or the same as to the first web page in response to determining that the portion of the content of the first web page has changed or the first web page is no longer valid, redirect the first user to the second web page, associate the first information with the second web page, and display the stored first information to the second user.

18. The system of claim 11, wherein the first web page comprises a plurality of first web pages in a domain and wherein:
the first browser is further configured to connect to different ones of the plurality of first web pages based on input from the first user; and
the first browser plug-in is further configured to receive second information about the different ones of the plurality of first web pages from the first user and wherein modifying a view of any one of the different ones of the plurality of first web pages comprises displaying the stored first information and the second information.

19. A method comprising:
defining first information associated with a first user, wherein the first information comprises interaction information with a second user;
sending the first information associated with the first user to be stored in a memory that is separate from a first web page;
defining an access rule for the first information, wherein the access rule for the first information allows the second user to access the second information;
connecting to the first web page based on input from the second user in a first browser, wherein the first web page is a first media social network where the first and second users have an account; and
in response to connecting to the first web page, modifying a view of the first web page presented to the second user, wherein modifying the view of the first web page presented to the second user comprises displaying content of the web page to the second user and displaying the first information to the second user based on the access rule.

20. The method of claim 19, wherein the information comprises an interaction between the first and second user outside the first social media network.
